(19) United States
(12) Patent Application Publication
(10) Pub. No.: US 2006/0011191 A1
(43) Pub. Date: Jan. 19, 2006

(54) Tile saw stand

(76) Inventor: Elmer Vavricek, Gardner, KS (US)

Correspondence Address: HENRICKS SLAVIN AND HOLMES LLP;SUITE 200, 840 APOLLO STREET, EL SEGUNDO, CA, 90245, US

(21) Appl. No.: 11/180,175

(22) Filed: Jul. 13, 2005

Related U.S. Application Data
(60) Provisional application No. 60/587,394, filed on Jul. 13, 2004.

(51) Int. Cl. B28D 1/04

(52) U.S. Cl. 125/13.01

(57) ABSTRACT

Apparatus and methods for using a tile saw stand includes wheels or other transport assists to make it easier to set up, move or store the tile saw. They may also or in the alternative include resilient elements, for example springs, to make it easier to set up the saw. The apparatus can also be made adjustable in height to make it easier for an operator to use.

### CROSS REFERENCE TO RELATED APPLICATIONS

This application claims benefit of priority to U.S. Provisional Patent Application Ser. No. 60/587,394 filed Jul. 13, 2004.

### BACKGROUND

1. Field

These inventions relate to stands for tile saws and other concrete and masonry saws.

2. Related Art

Tile saws are used to cut masonry, concrete, tile, stone and other natural or manufactured materials used in or about buildings and as paving, and the like. These saws generally include an abrasive or diamond cutting blade driven by a motor supported above or adjacent the tile or other work piece. The term “tile” will be used herein to represent any work piece of the type operated on by conventional tile saws. The tile is supported on a tile cart that moves the tile in a straight line for cutting. The tile cart is supported by a frame, which also supports a water/slurry pan for catching water and any slurry resulting from the cutting process. The frame and the rest of the saw can be supported on a workbench or other stable surface, or on a stand at the work site.

Many conventional tile saws are portable so that they can be used either on a workbench or at a remote work site. However, because of the weight of the motor and other components of the tile saw, which may be more than 50 pounds, the tile saw is sometimes difficult to store, transport and set up.

### SUMMARY

Apparatus and methods are described for supporting tile saws and similar equipment. The apparatus and methods provide for easier setup, use and transport. They may include a stand for making it easier to use the equipment, for example where the stand is adjustable in height to accommodate different users. The stand may also include wheels or other assists so that the equipment is easier to move and setup. Biasing components, for example springs, can be used also to help in setting up the equipment.

In one example of a saw, the saw includes a frame and cutting blade supported by the frame and driven by a drive motor. A stand supports the frame and includes at least one wheel on the stand contacting a surface such as the ground for supporting the equipment and for allowing easy movement of the equipment. In one example, the saw and motor for driving the saw are supported above a water or other material collection pan, and the motor is supported from a point off center of the saw. For example, the motor is supported from a point near one corner of the collection pan. In another example, the motor is supported from a point above the wheel.

In another example of a saw, the saw includes a frame and a motor and blade supported by the frame with a pan also being supported by the frame. A stand includes at least one wheel on the stand for supporting the stand on a surface for movement across the surface. In one example, the saw includes a motor stand extending from the pan to the motor for supporting the motor above the pan. The motor stand may be positioned above the wheel. The saw may also include a handle on a portion of the stand, for example in one configuration at a portion of the stand opposite the wheel. The stand can be configured so that it can extend to a raised configuration and collapse to a transport or storage configuration.

A further example includes a saw having a frame and motor and blade supported by the frame wherein the blade is used for cutting tile, stone, masonry, concrete or similar materials. A stand supports the frame, motor and blade, as well as other components of the saw. The saw stand includes a bias element, in one example a spring, which may be used to help in setting up the equipment. In one configuration, where the stand includes several stand support portions, the spring extends between and is coupled to the several stand support portions. The springs may be adjustable to different positions on one or more of the stand portions. For example, the springs may be moved from one set of openings to another set of openings on the stand support portions.

An additional example has a saw with a frame, motor and blade supported by a stand that is adjustable in height. The stand may include a plurality of holes to be used in adjusting the height. The stand has several structural portions each having one or more holes for receiving a pin to hold the stand at the desired height. The stand can be placed at a different height by putting the pin in another combination of holes. In one configuration, the pin can also serve as a pivot pin for two of the structural portions of the stand. The pin is preferably releasable so that the height of the stand can be adjusted as desired. The stand can also include one or more wheels and/or one or more springs or other components to help in setting up, using or storing the equipment.

Another example includes a saw having a frame and a motor and blade supported by the frame. The frame also supports a pan for collecting material during operation. A stand supports the frame and has first and second stand portions and at least one resilient element extending between them. The resilient element is configured to bias the first and second stand portions toward each other. The bias element may be a spring or other similar structure. In one example, the stand and bias element are configured so that the stand has a pivot pin located above an approximate mid-portion of the bias element. For example, where the bias element is a spring extending between two blade portions of a pivoting stand structure, the pivot point for the structure may be positioned approximately above a midpoint of the spring. The stand may be adjustable in height, for example through combinations of holes in the stand.

These and other examples are set forth more fully below in conjunction with drawings, a brief description of which follows.

### BRIEF DESCRIPTION OF THE DRAWINGS

FIG. 1 is a left side isometric view of a tile saw and stand in a folded or collapsed configuration disposed horizontally.

FIG. 2 is a left side isometric view of the tile saw and stand combination of FIG. 1 folded and with a handle lifted for transportation.

FIG. 3 is a left side elevation view of the tile saw and stand of FIG. 1 with the handle lifted for transportation.

FIG. 4A is a cross-section of a back portion of an upper frame element of a tile saw engaging a portion of a stand.

FIG. 4B is a cross-section of a front portion of an upper frame element of a tile saw engaging a portion of a stand.

FIG. 5 is a left side elevation view of the tile saw and stand of FIG. 1 in a folded horizontal orientation with a handle portion resting on a block

FIG. 6 is a left side isometric view of the tile saw and stand combination in an unfolded or extended configuration at a first height.

FIG. 6A is a left side isometric view of a stand that can be used for a tile saw in an unfolded or extended configuration at a first height.

FIG. 7 is a left side isometric view of the tile saw and stand combination at a second height lower than the first height.

FIG. 8 is a left side elevation view of the tile saw and stand combination of FIG. 6 at the first height.

FIG. 9 is a left front isometric view of a portion of an upper frame and stand for use with a tile saw such as that shown in FIG. 1.

FIG. 10 is a left side elevation view of the tile saw and stand combination of FIG. 7 at the second height.

FIG. 11 is a left side elevation view of a tile saw and folded stand with a plurality of wheels supporting the stand.

FIG. 12 is a left front isometric view of a stand and upper frame assembly for a tile saw showing the upper frame about to engage a portion of the stand.

FIG. 13 is a right side isometric view of a portion of the upper frame and stand for a tile saw showing the stand supporting the upper frame.

### DETAILED DESCRIPTION

The following specification taken in conjunction with the drawings sets forth examples of apparatus and methods incorporating one or more aspects of the present inventions in such a manner that any person skilled in the art can make and use the inventions. The examples provide the best modes contemplated for carrying out the inventions, although it should be understood that various modifications can be accomplished within the parameters of the present inventions.

Examples of tile saw stands and of methods of making and using the tile saw stands are described. Depending on what feature or features are incorporated in a given structure or a given method, benefits can be achieved in the structure or the method. For example, tile saw stands using wheels may be easier to move and stow. They may also be easier to set up. Tile saw stands that use springs or similar helping aids may benefit also from one or more features described, for example making it easier to set up.

Tile saw stands that are height adjustable may benefit also from one or more features described, for example making the saw easier to use and reducing strain.

In saw stands similar to tile saw stand configurations, one or more aspects of the examples described may allow easier assembly and/or storage or transport of the equipment.

These and other benefits will become more apparent with consideration of the description of the examples herein. However, it should be understood that not all of the benefits or features discussed with respect to a particular example must be incorporated into a stand, component or method in order to achieve one or more benefits contemplated by these examples. Additionally, it should be understood that features of the examples can be incorporated into a stand, component or method to achieve some measure of a given benefit even though the benefit may not be optimal compared to other possible configurations. For example, one or more benefits may not be optimized for a given configuration in order to achieve cost reductions, efficiencies or for other reasons known to the person settling on a particular product configuration or method.

Examples of a number of stand configurations and of methods of making and using the tile saw stands are described herein, and some have particular benefits in being used together. However, even though these apparatus and methods are considered together at this point, there is no requirement that they be combined, used together, or that one component or method be used with any other component or method, or combination. Additionally, it will be understood that a given component or method could be combined with other structures or methods not expressly discussed herein while still achieving desirable results.

Tile saw stands are used as examples of a stand that can incorporate one or more of the features and derive some of the benefits described herein, and in particular tile, stone, masonry or concrete saw stands. However, only tile saw stands will be described and stands other than tile stands can benefit from one or more of the present inventions.

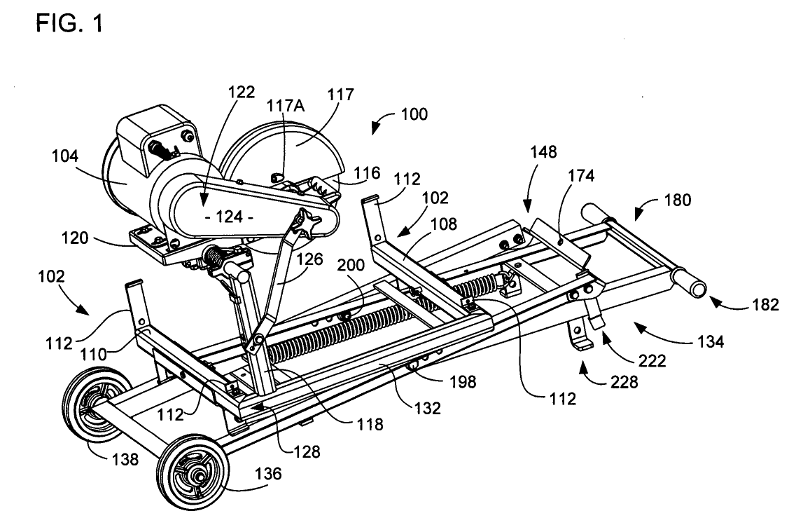

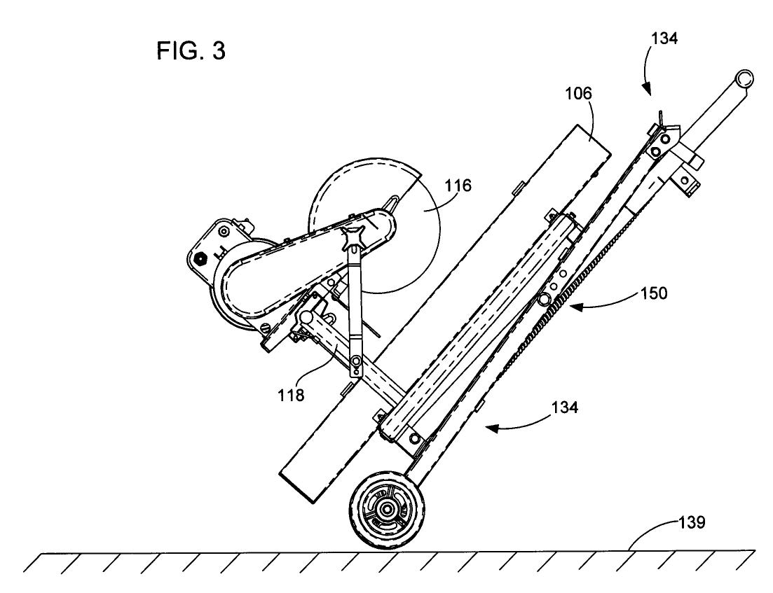

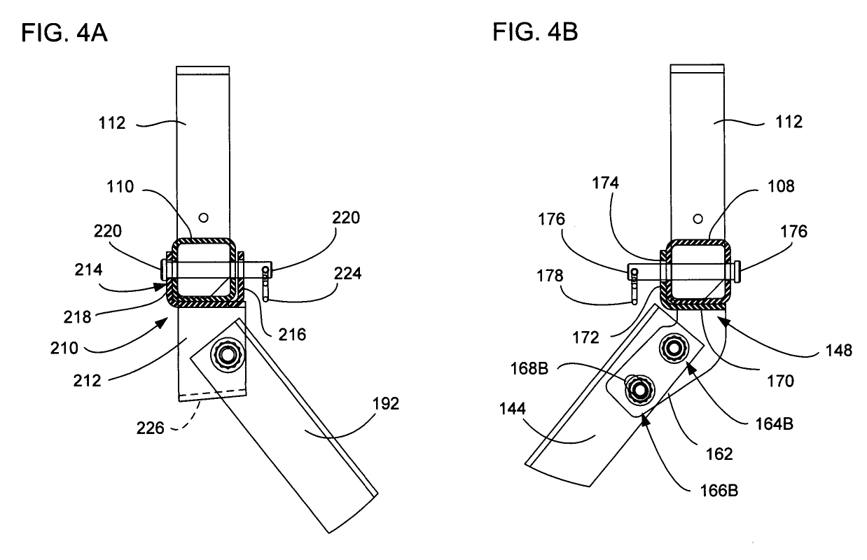

In one example of a saw and stand combination (FIGS. 1-8), the saw and stand combination 100 includes a saw frame 102 and the saw drive motor 104. The saw frame 102 in the present examples supports a pan 106 (FIG. 3) on a front bar 108 and a back bar 110 of the saw frame 102. The saw frame also includes side brackets 112 for supporting the pan from the sides. The side brackets are mounted to the front and back bars on or near the ends of the bars, and the pan fits between the side brackets and may extend forward of the front bar and rearward of the back bar as shown in FIG. 3. The size of the pan and its location on the saw frame 102 determine how much the pan extends forward of the front bar and rearward of the back bar. However, conventional pans typically have a size sufficient to extend under the motor 104 and the saw blade 116. The pan is preferably supported level on the saw frame 102 and collects water sprayed onto the blade and/or the tile, and also serves as a reservoir for water to be used to cool the blade. A pump and tubing collects water to pump the water onto the blade and/or onto the tile. Water may be applied through tubes, restrictions or other means that may be mounted adjacent the blade, such as through the blade guard 117, such as through the tubing opening 117A or adjacent the tile. The pan also collects particles or slurry produced during cutting. The pan is easily removable from the saw frame.

The saw frame also supports the motor 104 and the saw blade 116 through a stand or post 118. The post 118 extends substantially vertically from the saw frame to a motor platform 120, to which the motor is mounted. The saw blade 116 is also supported by the motor platform. The saw blade is preferably a conventional blade suitable for cutting tile, stone, masonry, concrete and other natural or manufactured materials used in or on buildings, pavement and the like. However, it should be understood that the examples described herein apply to work pieces other than tile and such materials. The saw blade is driven by the motor through a belt or other drive mechanism 122 having a housing 124 also supported by the post 118 through a support bracket 126. In the configuration shown in FIGS. 1-8, the post and therefore the motor and blade is supported on the saw frame 102 from a point near a left back corner 128 of the saw frame. In this configuration, the weight of the motor and the other components supported by the post 118 is off center relative to the saw frame and relative to the stand supporting the saw frame. However, the saw blade 116 is still positioned as it is with conventional tile saws, for example centered over a tile cart used for moving the tile or other work piece to the blade, even though the blade may not be centered over the pan or over the frame. Additionally, the orientation and positioning of the saw blade, motor and pan are substantially similar to the orientation and positioning for conventional blades and pans.

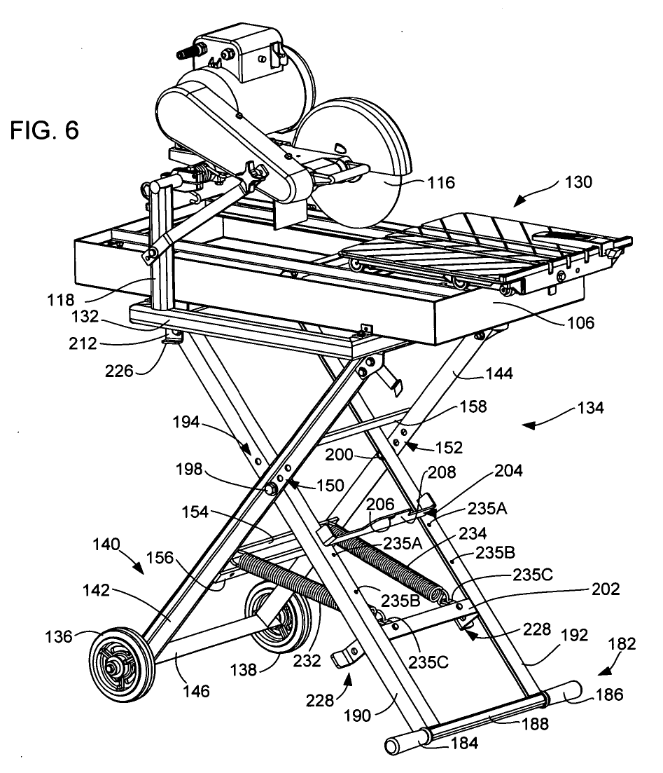

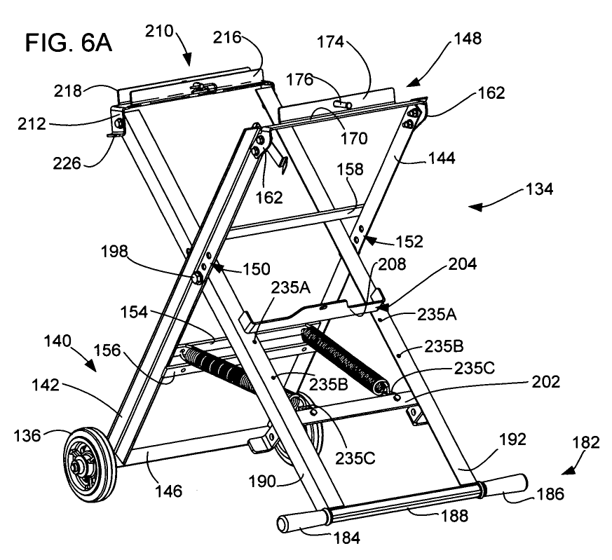

A tile cart 130 (FIGS. 6-8) runs along the upper portion of the pan and supports the tile for cutting by the saw blade 116. The tile cart is removable from the pan 106, and pan 106 is removable from the saw frame.

The saw frame 102 can take a number of configurations, but in the example shown in FIGS. 1-8, the saw frame has a U-shaped configuration formed by the front bar 108, the back bar 110 and a sidebar 132. The sidebar connects the front and back bars, and a portion of the sidebar 132 near the left back corner 128 supports the post 118. The bars forming the U-shaped saw frame can have a number of cross-sectional configurations, and in the example shown in FIGS. 1-8, the bars have a substantially rectangular cross-section with angled or flattened corners. However, other shapes can be used.

The saw frame 102 and tile saw and the pan can be supported on a tabletop, on the ground or on another support surface for cutting tiles. The saw can also be supported by a stand 134. The stand 134 allows the saw to be easily portable, and the saw can be moved to and used at remote locations. The stand can be used to position the saw at a height allowing the saw to be used easily by the operator.

In the present examples, the stand 134 uses a pivoting or scissor configuration to fold and unfold the stand, or to collapse or expand the stand. The terms “fold,”, “unfold,” “collapse,” and “expand” are used to describe the operation and end result of changing the stand configuration about the pivot point for raising and lowering the stand. These terms are used in the context of the pivoting movement of the stand and not in the context of folding a structure in half in the way of folding a piece of paper.

The stand 134 includes one and preferably two wheels 136 and 138 on a first or lower end portion of the stand. The wheels support the stand on a surface such as the ground 139 (FIG. 3) and assist in movement of the stand, such as over the ground when the stand is being moved. The wheel 136 is a left wheel mounted to a left side of a frame member 140 (FIG. 6) forming part of the stand, and the wheel 138 is a right wheel mounted to a right side of the frame member 140. In one example, the wheels are solid and may be mounted to the frame member 140 through a common axle or on separate pins in the frame. The frame member 140 will be called the wheel frame member 140 as being that frame member forming the stand to which the wheels are mounted, only for purposes of distinguishing it from the other frame member described below making up the tile saw stand.

The wheel frame member 140 has a generally rectangular construction formed by a left leg member 142 and a right leg member 144 extending substantially parallel to each other. The terms “left” and “right” as used herein are taken in the context of the sides of the saw and stand as seen by an operator standing in front of the tile cart 130. However, these terms are used only for ease of discussion, and do not indicate any required orientation. The left and right leg members are spaced apart by a bottom frame member 146 extending substantially horizontally and perpendicular to the left and right leg members. The wheels are rotatably attached to the bottom frame member 146. The wheels support the stand through the wheel frame member 140 and allow easy movement of the stand. Additionally, they also help in storing the stand, such as in the bed of a truck.

The left and right leg members extend lengthwise from the bottom frame member 146 to an opposite end where the opposite end portions of the left and right legs are spaced apart by a movable angle bracket 148. The angle bracket 148 is movable as described more fully below to allow more secure support for the saw frame, such as by engagement with a portion of the saw frame, namely the front bar 108 of the saw frame 102 when the stand is raised. Each of the left and right legs are formed from angle metal such as angle steel with horizontal portions facing at least partly upward and vertical portions facing each other toward an interior of the stand.

In the example shown in FIGS. 1-8, the vertical portions include position portions including at least one and preferably a plurality of holes 150 and 152, respectively, for engaging at least one corresponding hole in an adjacent stand frame member, described below. The position portions and the holes 150 and 152 allow adjustment of the stand height, thereby allowing the tile saw to be placed at a desired height for the operator. In the present examples, each of the left and right leg members include three identically positioned holes distributed along the position portions, wherein the holes in a given set of three are spaced apart from each other longitudinally along the leg member, with equal spacing.

An outer cross bar 154 separates and supports the left and right leg members. The outer across bar 154 is positioned approximately midway between the inside and outside of the vertical portion of the angle metal. An inner cross bar 156 also separates and supports the left and right leg members. The inner cross bar 156 is mounted to the lower edge surface of the vertical portion of the angle metal.

An upper cross bar 158 separates and supports the left and right leg members just above the holes 150 and 152. The upper cross bar 158 is mounted on the horizontal portions of the angle steel. The upper cross bar 158 also helps to keep the stand from unfolding completely especially when the stand is set at its lower height.

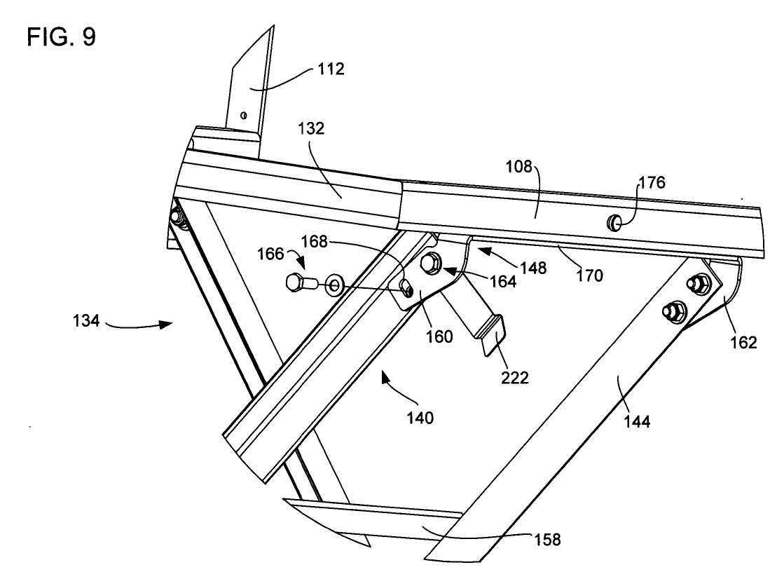

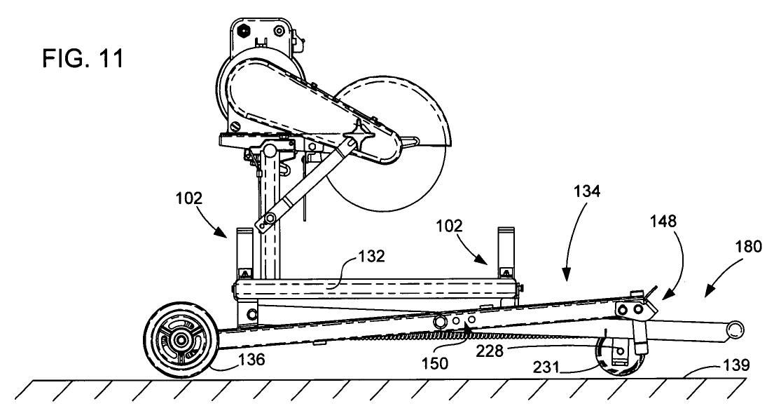

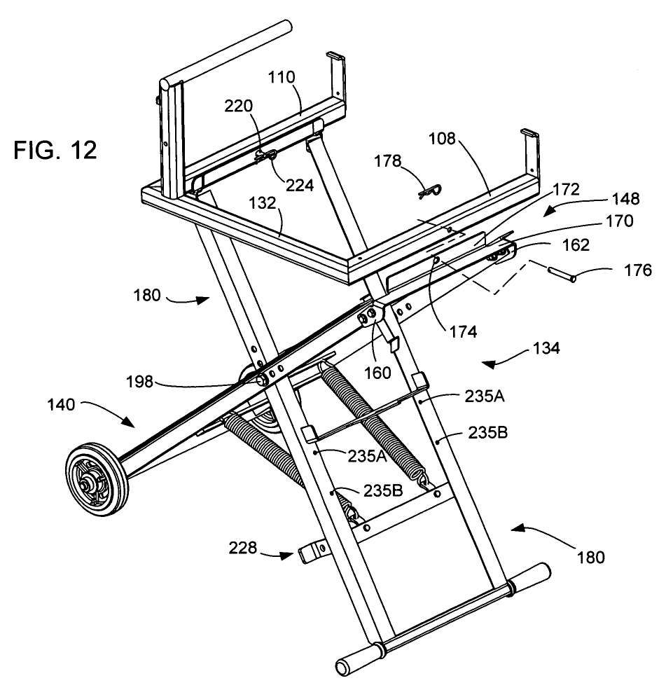

The wheel frame member 140 includes a support or other means for supporting the saw frame, which in turn supports the pan 106, and in the examples herein, the support includes the angle bracket 148. The angle bracket 148 can take a number of configurations, and in the present examples (FIGS. 11-12) is an outwardly-facing right angle bracket having left and right side flanges 160 and 162, respectively, for mounting the angle bracket on respective left and right leg portions of the wheel frame. The left side flange 160 (FIG. 9) is mounted to the left leg portion 140 through first and second fasteners 164 and 166 extending through and fastened within openings in the side flange and in the left leg portion. The second fastener 166 extends through an elongate opening 168 in the side flange 160. The elongate opening 168, along with a similar opening in the right side flange 162, allows the angular position of the angle bracket 148 to be adjusted about the first fastener 164 and then fixed with the fasteners to more securely support the saw frame 102. The angle bracket preferably fits snugly against the front bar 108 to more securely hold it supported with the stand.

The angle bracket 148 (FIGS. 9 and 12) includes a horizontal plate 170 and a vertical plate 172. The horizontal plate 170 supports a lower surface of the front bar 108. The vertical plate 172 supports an adjacent inside vertical surface of the front bar 108. The front bar limits outward movement of the angle bracket 148, and thereby reduces the possibility that the stand will fold down from the weight of the saw. The vertical plate 172 also preferably includes an opening 174 approximately centered in the vertical plate 172 for receiving a locking pin 176 extending through the front bar 108. The locking pin 176 helps to lock the stand and saw assembly in the upright, raised, unfolded or extended position. A secondary pin 178 may extend through a corresponding opening in the pin 176 to lock the pin 176 in place, thereby locking that portion of the saw frame in place. In other configurations, the saw frame supporting means on the wheel frame element has at least one form that conforms to a shape of the saw frame or other support for the pan 106. Therefore, where the saw frame has a front bar that has a round cross section, the saw frame supporting means has a round configuration conforming to the saw frame member. Alternatively, where the saw frame member has an engagement surface, the saw frame supporting means can include a complimentary engagement mechanism.

The other frame member making up the tile saw stand will be called a handle frame member 180 because the example of the frame member shown in FIG. 1-8 includes a handle. However, the structure of the handle frame member 180 need not include a handle shaped for manual gripping because the other frame member may include inherently structures that can be grabbed by hand. In the present examples, the other frame member 180 includes a handle 182 at a lower portion of the frame member. The handle 182 includes a left and right handle 184 and 186, respectively, supported on a cross bar 188 extending between a left leg portion 190 of the frame element and a right leg portion 192. The handle 182 supports the stand on the ground or other surface, and also serves as a hand hold for grasping the stand, for moving the stand and for folding or unfolding the stand, if desired. It also serves as a foot for the other frame member when the stand is raised to support a saw for cutting. The handles 184 and 186 and the cross bar 188 can take a number of configurations, but preferably can withstand heavy use and constant contact with the ground and other hard surfaces.

The left and right leg members of the handle frame are formed substantially the same as the leg members of the wheel frame. At approximately the same locations as for the wheel frame, position portions include at least one and preferably a plurality of holes 194 and 196 formed in the left and right leg portions for allowing height adjustment of the stand for engaging a corresponding hole or holes in the wheel frame member. In the present example, each of the left and right leg members include three identically positioned holes, wherein the holes in a given set of three are spaced apart from each other longitudinally along the leg member. The lowest hole in the left leg member for the wheel frame is preferably the same distance from the ground contact point as the lowest hole in the left leg member for the handle frame. The same comments apply with respect to the middle holes and the upper holes in the left leg members and also to each of the holes in the right leg members. The spacing allows the saw frame to be supported level on the stand without additional supports or adjustments.

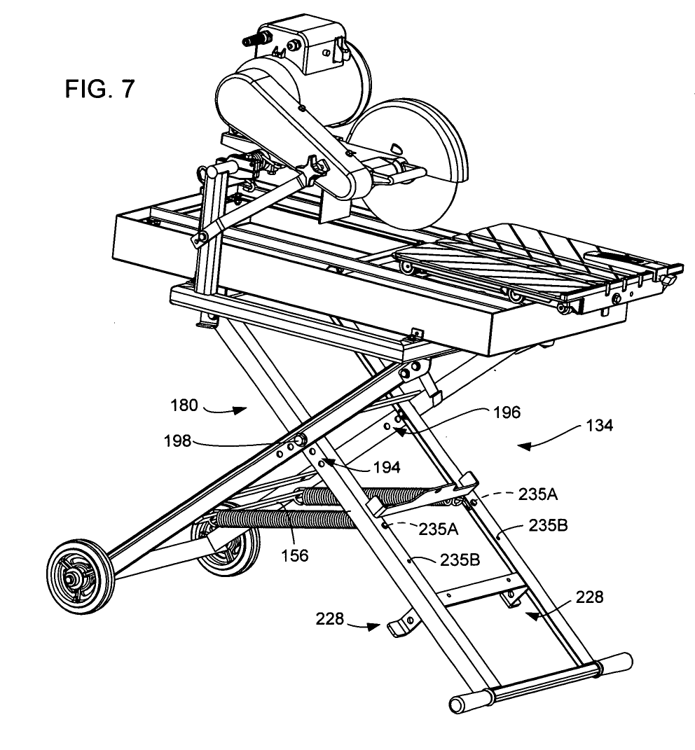

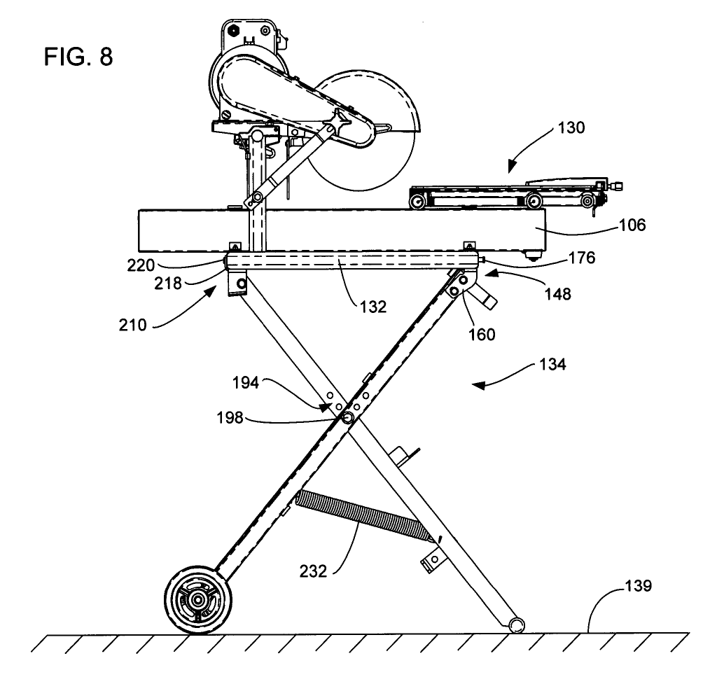

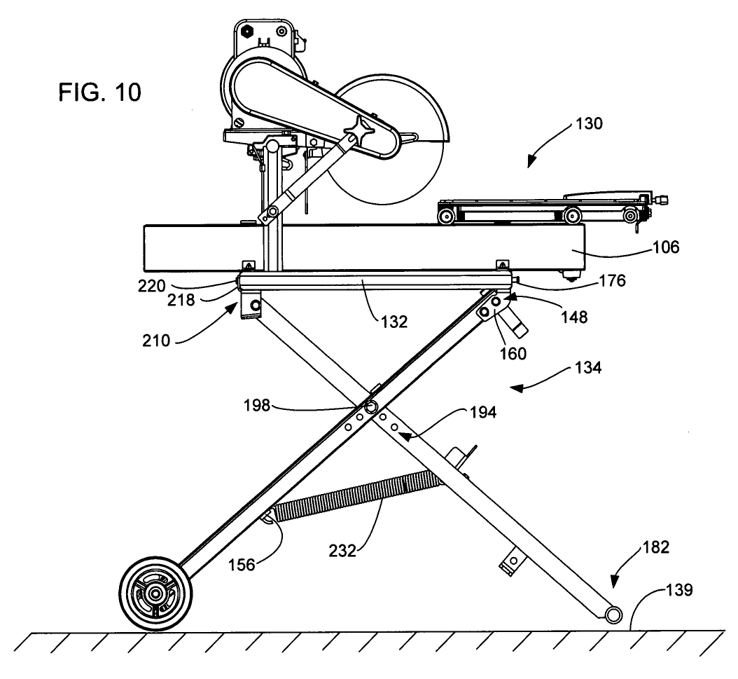

The left leg members are held for pivoting movement by a pivot pin such as the bolt 198 and the right leg members are held for pivoting movement by a similar pivot pin such as the bolt 200 (FIGS. 1 and 6). The holes and the pivot pins allow pivoting movement of the frame elements of the stand about a pivot axis coaxial with the pivot pins to permit unfolding or raising of the stand and folding or collapsing of the stand by the user. The combinations of holes allow the raised height of the stand to be adjusted, to at least three height positions using the hole combinations shown in FIGS. 1-8. Pairs of holes for the left legs and for the right legs can be aligned and engaged by the pivot pins. Selective engagement of the holes allows various heights to be achieved with the stand. For example, in FIGS. 6 and 8, the lower most pairs of holes are engaged to allow the stand to have a first position at a relatively higher height or vertical position. In FIGS. 7 and 10, the upper most pairs of holes are engaged to allow the stand to have a second position at a relatively lower height or vertical position. Instead of combinations of a bolt and nut, a single pivot rod may extend between the legs.

The stand frame elements can take a number of configurations, and the position portions can also take a number of configurations. The stand frame elements are formed from linear one-piece segments, but they can also be formed from multiple piece segments and still provide desired height adjustments. Additionally, position portions can be placed at a number of locations on the stand frame elements or elsewhere while still permitting height adjustments in the stand. The leg portions can also have other configurations while still providing reliable support for the saw. Additionally, the stand components can be combined in a number of ways to provide a reliable support for a tile saw, including one that keeps the pan level at a number of height positions.

The handle frame includes a lower cross bar 202 spacing apart and supporting the left and right leg portions of the handle frame. The handle frame also includes an upper cross bar 204 also spacing apart and supporting the left and right leg portions of the handle frame. The upper cross bar 204 extends perpendicular upward from the horizontal portions of the left and right legs. When the stand is lowered or folded the upper cross bar 204 moves next to and engages the front bar 108 on the saw frame to support the saw frame. The upper cross bar 204 helps to encapsulate the saw frame. The pin 176 (FIG. 12) can then be inserted into an opening 206 in the upper cross bar 204 and then into the front bar 108 to hold the stand and saw frame in the folded or lowered position. The upper cross bar 204 includes an outer plate 208 that extends on the outside of the front bar 108 when in the folded position.

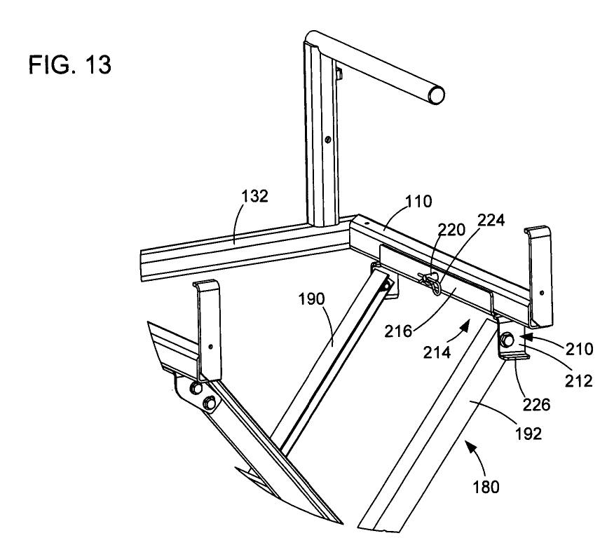

The frame member 180 in the present examples also includes a support for a portion of the saw frame or other element or means for supporting the pan 106. In the present examples, the frame member 180 has a support at an upper portion of the handle frame member 180 (FIG. 8 and 13) in the form of a pivoting cross bar 210 extending from the left leg portion 190 to the right leg portion 192 separating the two leg portions. The pivoting cross bar 210 floats freely with respect to the handle frame member. The cross bar 210 also supports the back bar 110 of the saw frame. Each side of the pivoting cross bar 210 includes a side flange 212 for mounting the pivoting cross bar 210 to the adjacent leg portion of the handle frame. The side flange 212 is held in place for pivoting movement by a pivot pin or other means for securing the side flange 212 on the adjacent leg portion for pivoting movement. In the example shown in FIGS. 8 and 13, the pivot pin is a nut and bolt combination but may take other configurations. The same or similar side flange and pivot pin combination supports the pivoting cross bar 210 on the left leg portion 190. The side flanges and the pivot pins are configured to allow a large angular range of motion of the pivoting cross bar relative to the handle frame 180 including having the sidebar 132 extending adjacent the left leg portion 190.

The pivoting cross bar 210 also includes a U-channel 214 extending in a direction substantially opposite the direction in which the side flanges 212 extend. The U-channel 214 includes an inward-facing wall 216 for extending upward adjacent an inner wall of the back bar 110 and supporting the back bar 110 against movement in the direction of the wall 216. The U channel 214 also includes an outward-facing wall 218 (FIG. 8) extending upward adjacent and outer wall of the back bar 110 and supporting the back bar 110 against movement in the direction of the wall 218. A locking pin 220 can extend through the walls 218 and 216 and the back bar 110 to lock that portion of the saw frame to the stand. The pin 220 can be locked in place through a secondary pin 224 (FIG. 13). The pin 220 can be kept in place at all times while the saw is mounted on the stand, both in the raised or extended configuration and in the folded or lowered configuration, helping to hold the saw in place on the stand. The pins 224 and 220 can be removed to allow removal of the saw from the stand, but can remain in place to help hold the saw in place at all times while the saw remains supported by the stand. In other configurations, the saw frame supporting means on the handle frame element 180 has at least one form that conforms to a shape of the saw frame or other support for the pan 106. Therefore, where the saw frame has a back bar that has a round or other cross section, the saw frame supporting means has a round configuration or other configuration conforming to the saw frame member. Alternatively, where the saw frame member has an engagement surface, the saw frame supporting means can include a complimentary engagement mechanism.

The handle frame element 180 also includes tabs or other supports, for example on the pivoting cross bar 210, for contacting the wheel frame element when the stand is in the folded or lowered configuration. In the examples shown in FIGS. 1-13, tabs 226 (FIGS. 6 and 13) extend downward and outward from the side flanges 212 for contacting the opposite facing surfaces of the wheel frame elements as the stand folds. The tabs 226 limit the extent to which the frame elements can fold together.

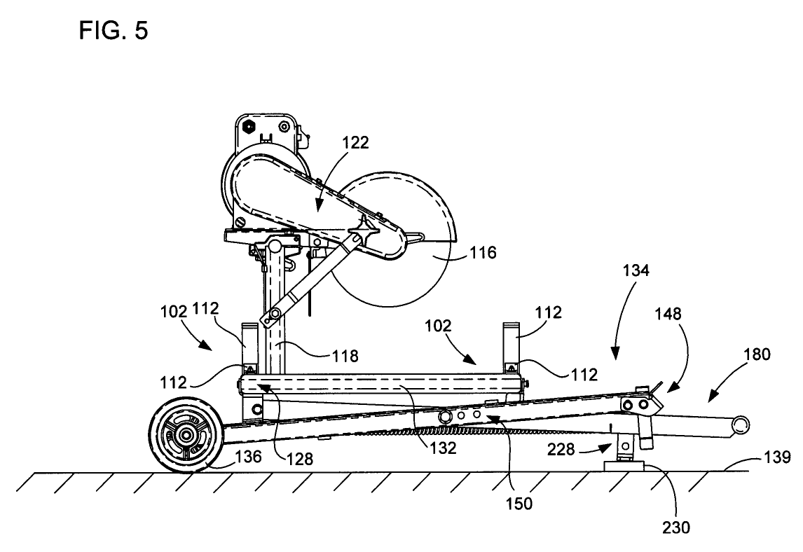

The handle frame element 180 can also include one or more extensions extending downward from the frame element for supporting the handle frame element on the ground or other surface, and possibly for other functions. In the example shown in FIGS. 1-12, extensions 228 extend downward from the handle frame element 180 and are formed integral with the cross bar 202 for ease of fabrication. The extensions 228 may be used to support the tile saw, for example on the ground or other support surface when the stand is in a folded or lowered configuration. The extensions allow the saw to be used when the stand is in a folded configuration. A shim or other support 230 (FIG. 5) may be used to level the saw. The extensions may also provide clearance for the handles to allow the user to grasp the handles without contacting the support surface or the ground 139. The extensions may also hold an extension cord wound about the extensions. Additionally, the extensions can be used to help in raising or unfolding the stand. For example, the user may step on the handle 182 and lift the stand by pulling the extensions 228 upward. In another example, the extensions may also provide mounting supports (FIG. 11) for optional wheels 231 that can be releasably supported by the extensions 228. The wheels 231 can assist in rolling the saw or the stand during loading and unloading the equipment from a vehicle or other storage location. A single wheel 231 may be provided or multiple wheels. The extensions 228 can also support other assists for making easier the movement of the stand during transport of the stand. Such other assists may include casters, rollers, slides, skids or the like.

The motor and saw blade support, in the present examples the post 118, is preferably positioned closer to the wheels than to the handle. As seen most clearly in FIGS. 5, 8, 10 and 11, the post 118 is more closely aligned with the wheels 136 and 138 than with the handle 182. For example, the post 118 extends on the wheel side of the pivot pins 198 opposite the handle 182. Additionally, the post 118 is on the wheel side of the center of the pan 106. The handle 182 is on the side of the pivot pins 198 opposite the wheels, and on a side of the motor opposite the wheels. With the weight of the saw supported over the wheels, it is easier to lift the stand by the handle 182 and have the wheels support a significant amount of the weight from the saw.

The stand may also include at least one resilient or biasing element coupling the two stand frame elements for assisting in either the folding or unfolding of the stand or both. In the examples shown in FIGS. 1-12, at least one spring and in the example left and right springs 232 and 234 extend between the wheel and handle frame portions. In the present examples, the springs are identical tension springs biasing the lower portions of the frame elements together about the pivot points. The springs are positioned below the pivot elements 198 and 200. In the illustrated examples, the left and right springs are coupled and supported at the handle frame on the lower cross bar 202. The springs are removable from the handle frame for disposal or replacement, but are preferably reliably held in place during normal operation. The other ends of the springs 232 and 234 are supported on one or the other of the cross bars 154 and 156. The springs 232 and 234 are configured so as to bias the lower portions of the stand frame elements together when the stand is in a folded configuration until the stand is unfolded sufficiently to the desired height. In the folded configuration as shown in FIGS. 1-3, 5 and 11, the springs are extended and produce a significant return force biasing the stand to an unfolded configuration to extend upward to the desired height. The desired height will be determined by the location of the pivot pins 198 and 200 in the respective pairs of holes in the left and right leg portions of the frame elements and by the spring configurations in terms of spring constant, spring length, spring position and the amount the springs are stretched.

The spring configurations can be adjusted by the user as a function of the desired height. For example, as shown in FIG. 6 for the higher height configuration where the pivot pins 198 and 200 are in the lower pairs of holes, the springs 232 and 234 are mounted to the outer cross bar 154 on the wheel frame, and to the lower cross bar 202 on the handle frame. Mounting to the outer cross bar 154 and the lower cross bar 202 gives the desired return force in the springs for the final height of the stand when the lower frame elements of the stand do not end up as far apart as when the pivot pins are in other hole pairs. Alternatively, as shown in FIG. 7 for the lower height configuration where the pivot pins 198 and 200 are in the upper pairs of holes, the springs 232 and 234 are mounted to the inner cross bar 156 on the wheel frame and to the upper pair of holes 235A in the handle frame through the tabs 235C (FIG. 6). At the lower height, the lower frame elements are spaced further apart, thereby producing a longer spring extension at the desired height. Therefore, to produce the same return force for the different heights, the springs are mounted at different positions. For the mid-level height, where the pivot pins are in the middle holes, the springs 232 and 234 are mounted to the inner cross bar 156 on the wheel frame member and to the intermediate holes 235B on the handle frame member, through the tabs 253C.

Other configurations for the springs can be used to produce the desired effect, for example bringing the wheel and frame elements toward each other. The springs are preferably configured to be identical between each other. When the pivot pins 198 and 200 are in the center hole configurations, the pivot pins are the top of a substantially isoceles triangle, the bottom which includes the springs. The pivot pins are substantially centered above the springs so that a shortest line from the pivot pins to the springs is substantially perpendicular to the direction in which the springs extend (normal to the springs). Having the springs movable between two or more different attachment points allows adjustment so that the springs develop substantially the same amount of force for the different height selections. Preferably, the different spring positions correspond to the different height positions, such as those height positions selectable through sets of openings in the legs of the stand.

In the exemplary configurations of the stand and saw combination, the saw assembly can be supported on the stand through one or more latch pins, such as the pins 176 and 220. The pins are preferably releasable so the saw assembly can be removed easily from the stand and used separate from the stand, for example on the ground, a bench top or other supporting surface. The pins 176 and 220 securely support and hold the saw assembly together with the stand. In the examples described herein, the pin 220 is always in-place when the saw assembly is supported on the stand. When the stand is folded or collapsed, the pin 176 holds the front bar 108 to the upper cross bar 204 through the hole 206. When the stand is in the raised or unfolded condition, the pin 176 holds the front bar 108 to the angle bracket 148, such as shown in FIGS. 8, 9 and 10. The joinder of the front bar and the angle bracket with securement of the saw frame to the stand is depicted in FIG. 12. The pins 176 and 220 may take a number of configurations, and may include latch mechanisms, spring activated pins or other constructions suitable for locking and un-locking the frame from the stand. When the stand is folded or collapsed, a holder 222 (FIG. 1) on the wheel frame can engage or otherwise hold a portion of the handle frame to help hold the folded frame configuration during movement and storage.

When the tile saw assembly is supported on the stand, folding of the saw and stand assembly is made easier, and transporting the assembly from one location to another is also made easier. At a job site, the assembly can be unfolded and the stand with the saw assembly supported thereon can be unfolded and raised to the desired height. The height is determined by the selection of the pivot pins and the corresponding pairs of holes in the legs of the wheel and handle frame elements, and the saw assembly is locked in position by the pin 176 extending through the hole 174 in the angle bracket into a corresponding opening in the front bar 108. The water pan and the tile cart can be added after the stand is raised, though they can also be supported on the saw assembly during transportation. For example, the saw and stand assembly can be moved when the stand is raised, for example with the assistance of the wheels on the wheel frame element.

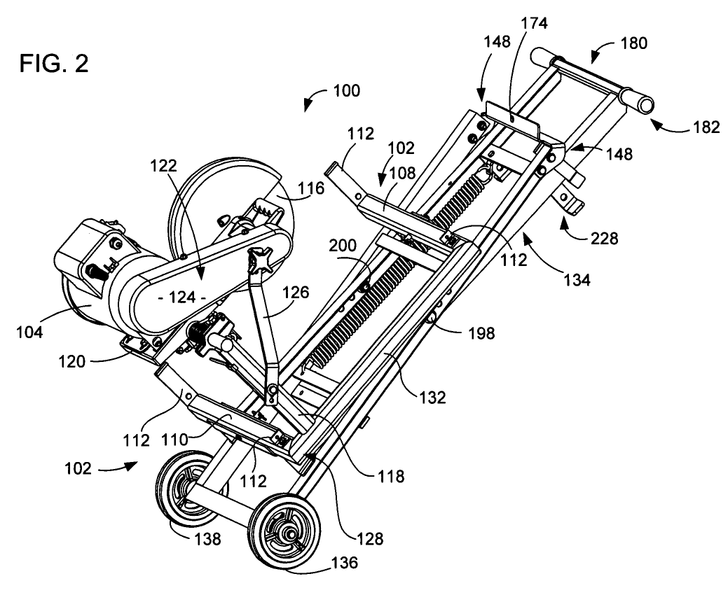

In operation, the stand and/or saw assembly assembled with a stand can be moved by grasping handle 180 and rolling the stand on the wheels to the desired location. While the stand and assembly can be moved when the stand is raised, the stand and assembly can be easily moved when the stand is folded or in the collapsed configuration with the pin 176 locking the saw frame to the upper cross bar 204. The assembly can be moved in a manner similar to using a dolly (FIGS. 2-3), and a substantial portion of the weight of the saw assembly is supported more on the wheels than on the handle. When at the desired location, the saw and stand assembly may be placed on the ground (FIG. 5) and the pin 176 removed. The user may place a foot on the handle 180 and lift the wheel frame element so the saw frame engages the angle bracket 148. The springs, if installed, biases the stand upward to the desired height, thereby making it easier for the user to lift the stand and saw assembly.

Typically the user will have positioned the pivot pins 198 and 200 in the appropriate pairs of holes so that the saw is supported at the desired height. The height will be selected and configured with the saw assembly and pan removed and the pivot pins placed as desired. The saw assembly and pan can then be assembled on the stand for use. In the configurations shown in FIGS. 6 and 8, the saw is at a higher raised position, and the springs are mounted between the lower cross bar 202 and the outer cross-bar 154. In the configurations shown in FIGS. 7 and 10 the saw is at a lower raised position and the springs are mounted between the upper holes 235A and the inner cross bar 156. When at the desired height, the front bar 108 engages the angle bracket 148 and the pin 176 latches them together.

To remove the saw assembly, the pins 176 and 220 are removed and the saw frame and other components removed from the stand. To fold the stand and saw assembly, without removing the saw assembly from the stand, the pin 176 is removed and the user pushes down on the saw frame and/or the wheel frame element to fold the stand together. The user can hold the handle 182 at the same time. Once the front bar 108 is adjacent the bracket 204, the pin 176 can be re-inserted, thereby holding the stand and saw assembly in the folded configuration for transportation and/or storage.

Having thus described several exemplary implementations, it will be apparent that various alterations and modifications can be made without departing from the concepts discussed herein. Such alterations and modifications, though not expressly described above, are nonetheless intended and implied to be within the spirit and scope of the inventions. Accordingly, the foregoing description is intended to be illustrative only.

What is claimed is:

1. A saw comprising:
a frame;
a saw drive motor supported by the frame;
a support element extending between the frame and the motor so as to support the motor above the frame;
a saw blade coupled to the saw drive motor for being driven by the saw drive motor and supported above the frame;
a pan below the saw blade and supported by the frame and configured to receive fluid;
a stand supporting the frame wherein the stand supports the frame on a surface suitable for operating the saw; and
at least one wheel on the stand and configured to contact the surface for supporting the frame so as to allow rolling movement of the saw on the surface.

2. The saw of claim 1 wherein the at least one wheel includes first and second spaced apart wheels supported on the stand.

3. The saw of claim 1 further comprising a handle.

4. The saw of claim 1 wherein the support element is a post extending away from the frame to the motor.

5. The saw of claim 4 wherein the post supports the motor so that the motor is raised from the pan.

6. The saw of claim 1 wherein the frame has a center and a wheel side on which the at least one wheel is supported and on a first side of the center and a handle on a handle side of the stand on a second side of the center different from the first side of the center, wherein the stand supports the motor from the first side of the center.

7. The saw of claim 1 further including a fluid supply for supplying fluid to the blade.

8. A saw for cutting masonry or concrete, the saw comprising:
a frame;
a motor supported by the frame;
a tile, stone, concrete or masonry blade driven by the motor;
a pan supported by the frame below the blade for receiving fluid during operation of the saw;
a stand supporting the frame and motor and pan, the stand including at least one wheel on the stand for support the stand on a surface for movement of the saw across the surface.

9. The saw of claim 8 further including a motor stand extending from adjacent the pan to the motor for supporting the motor above the pan.

10. The saw of claim 9 wherein the motor stand is positioned on a side of the saw the same as the at least one wheel is positioned.

11. The saw of claim 8 further including a handle on a portion of the stand spaced apart from the at least one wheel.

12. The saw of claim 11 wherein the stand includes means for allowing the stand to extend and collapse.

13. The saw of claim 12 wherein the stand includes a pivot element for allowing the stand to extend and collapse.

14. The saw of claim 13 wherein the stand includes a bias element.

15. The saw of claim 14 wherein the bias element is a spring.

16. The saw of claim 14 wherein the bias element includes a position on the stand and wherein the position is changable from a first position to a second position.

17. The saw of claim 16 wherein the stand includes openings for changing the height of the stand.

18. The saw of claim 17 wherein the stand has at least two height positions and wherein the bias element can be configured to be at at least two positions on the stand.

19. The saw of claim 8 further including structures for changing the height of the stand.

20. The saw of claim 19 wherein the structures include a plurality of holes for allowing the height of the stand to be changed.

21. The saw of claim 20 further including a pin and wherein at least one of the holes receives the pin for fixing the height of the stand.

22. The saw of claim 21 wherein the stand includes a first portion having a first hole and a second portion having a second hole and wherein the pin engages the first and second holes for fixing the height of the stand.

23. The saw of claim 22 wherein the stand first portion extends at an angle to the stand second portion.

24. The saw of claim 22 wherein the stand first portion and the stand second portion are releasably secured together by at least one pivot pin SO that the first and second stand portions can pivot relative to each other.

25. The saw of claim 8 further including releasable holding means for holding the pan on the frame.

26. The saw of claim 25 wherein the releasable holding means includes a pin.

27. The saw of claim 25 wherein the frame includes a pivot portion for pivoting relative to the stand, and wherein the pan is supported by the frame with a releasable pin engaging the pivot portion on the frame, and wherein the releasable holding means is a second pin engaging the frame.

28. The saw of claim 8 wherein the stand includes first and second stand portions pivotably coupled together and further including at least one wheel coupled to the first stand and wherein the motor is supported by the second stand portion substantially above the at least one wheel.

29. The saw of claim 28 wherein the stand includes holes in the stand for adjusting a height of the stand.

30. A saw comprising:
a frame;
a power source supported by the frame;
a blade driven by the power source;
a pan supported by the frame under a cutting portion of the blade for receiving fluid during operation of the saw;
a stand supporting the frame and power source and pan, the stand including first and second stand portions and at least one resilient element extending between the first and second stand portions and configured to bias the first and second stand portions toward each other.

31. The saw of claim 30 wherein the at least one resilient element is a spring extending between the first and second stand portions.

32. The saw of claim 31 wherein the first and second stand portions are coupled together by a pivot pin and wherein the spring is coupled to a first point on the first stand portion and to a second point on the second stand portion such that the first and second points and the pivot pin form three points defining an approximate isoceles triangle.

33. The saw of claim 31 wherein the spring extends in a first direction and wherein a shortest distance from the pivot pin to the spring is along a line substantial perpendicular to the first direction.

34. The saw of claim 30 wherein the resilient element is coupled to the first and second stand portions and wherein the spring can be attached to the first stand portion at at least two positions.

35. The saw of claim 34 wherein the stand is adjustable in height.

36. The saw of claim 35 wherein the stand includes holes for adjusting the height of the stand.

37. The saw of claim 30 wherein the stand includes holes for adjusting a height of the stand.

38. The saw of claim 37 wherein the first and second stand portions are movable with respect to each other and wherein the first and second stand portions include holes for adjusting the height of the stand.

39. A saw comprising:
a frame;
a power source supported by the frame;
a blade driven by the power source;
a pan supported by the frame under a cutting portion of the blade for receiving fluid during operation of the saw;
a stand supporting the frame and power source and pan, the stand including first and second stand portions and at least first and second position portions in each of the first and second stand portions for putting the stand in either of first and second raised stand positions.

40. The saw of claim 39 wherein the first and second position portions include holes for adjusting the position of the stand.

41. The saw of claim 40 wherein each of the first and second position portions include holes.

42. The saw of claim 41 wherein the first and second stand portions include respective first and second frame elements having the first and second position portions and wherein the holes are formed in each of the first and second frame elements.

43. The saw of claim 42 wherein the first and second frame elements are coupled together through a pivot pin extending through a hole in each of the first and second frame elements.

44. The saw of claim 43 wherein the height is adjustable by moving the pivot pin from a first set of holes in the first and second frame elements to a second set of holes in the first and second frame elements.

45. The saw of claim 39 further including a water supply for supplying water to the blade.

46. The saw of claim 39 wherein the blade is a tile cutting blade.
